(19) United States
(12) Patent Application Publication
(10) Pub. No.: US 2011/0155826 A1
(43) Pub. Date: Jun. 30, 2011

(54) FUEL INJECTION VALVE

(76) Inventors: Andreas Kerst, Stuttgart (DE); Thorsten Rankel, Ditzingen (DE)

(21) Appl. No.: 12/737,907

(22) PCT Filed: Jul. 7, 2009
(86) PCT No.: PCT/EP2009/058556

§ 371 Date: Feb. 28, 2011

(30) Foreign Application Priority Data
Aug. 29, 2008 (DE) 10 2008 041 676.2

(51) Int. Cl. F02M 61/10

(52) U.S. Cl. 239/584

(57) ABSTRACT

The invention relates to a fuel injection valve, particularly used as injector for fuel injection units of air compressed, self igniting internal combustion engines. According to the invention, a nozzle body with a valve seat surface and a nozzle needle interacts with the valve seat surface as a sealing seat in order to control a fuel flow to an injection hole located downstream of the sealing seat of the nozzle body. The injection hole is rounded at an inflow region. The injection hole further includes a tapering and a cutting edge at an outer region of the hole. Thus high efficiency atomization of fuel close to the nozzle is possible.

The invention relates to a fuel injection valve, in particular an injector for fuel injection systems of air-compressing, self-igniting internal combustion engines.

A fuel injection valve for internal combustion engines is known from German Patent Disclosure DE 103 15 967 A1. The known fuel injection valve has a valve body in which a pressure chamber is embodied, in the wall of which chamber an injection conduit is disposed. The injection conduit extends in the valve body, and forms an outlet opening on the outside of the valve body. The injection conduit, viewed in the flow direction, includes a first conical portion and an adjoining second conical portion. The two conical portions taper in the flow direction. The two conical portions also have different opening angles.

In the fuel injection valve known from DE 103 15 967 A1, good atomization and directional stability of the injection stream can be attained.

### Disclosure of the Invention

### Advantages of the Invention

The fuel injection valve of the invention having the characteristics of claim 1 has the advantage that further optimization of atomization near the nozzle, with high efficiency, is possible. Especially, atomization near the nozzle can be effected without causing substantial worsening of the efficiency. In particular, deflection losses can essentially be avoided or prevented entirely.

By the provisions recited in the dependent claims, advantageous refinements of the fuel injection valve recited in claim 1 are possible.

Advantageously, the inflow region of the injection port is embodied in rounded form, while the outer port region is embodied as sharp-edged and burr-free. The rounded inflow region preferably merges with a valve seat face uniformly and without corners. As a result, a largely loss-free inflow of fuel into the injection port is attained, and an at least largely loss-free ejection in the outer port region is made possible.

It is also advantageous that a wall of the injection port is embodied such that a flow line extending in the flow direction along a surface of the wall is embodied in kink-free fashion. As a result, eddies in the vicinity of the surface of the wall of the injection port are prevented, thus reducing flow losses.

In particular, it is advantageous that the flow line extending along the surface of the wall is embodied as S-shaped; the S-shaped embodiment also preferably extends, over the inflow region and the outer port region.

It is advantageous that a cross-sectional area of the injection port, located perpendicular to an axis of the injection port oriented in the flow direction, decreases continuously in the flow direction along the axis. Thus a steady narrowing of the injection port in the flow direction is attained, which can extend uniformly, at least in a middle portion. As a result, the efficiency can be optimized. It is furthermore advantageous that the cross-sectional area in the outer port region decreases to a relatively strongly pronounced extent along the axis in the flow direction. The decrease in the cross-sectional area can decrease uniformly in a middle region between the inflow region and the outer port region in the flow direction; the decrease in the cross-sectional area in the flow direction in the middle region is preferably relatively slightly pronounced. As a result, a deflection can be attained which takes place in the middle region toward the axis and is more markedly pronounced in the outer port region. As a result, atomization close to the nozzle with efficiency can be attained.

It is furthermore advantageous that a detachment edge, which is oriented toward the axis of the injection port, is provided in the outer port region of the injection port. As a result, the atomization of the ejected fuel can be improved.

### BRIEF DESCRIPTION OF THE DRAWINGS

Preferred exemplary embodiments of the invention are described in further detail in the ensuing description in conjunction with the accompanying drawings, in which elements corresponding to one another are identified by the same reference numerals. Shown are:

FIG. 1, a schematic illustration of a fuel injection valve in a fragmentary sectional view, corresponding to one exemplary embodiment of the invention; and

FIG. 2, the fragment marked II in FIG. 1, in further detail.

### EMBODIMENTS OF THE INVENTION

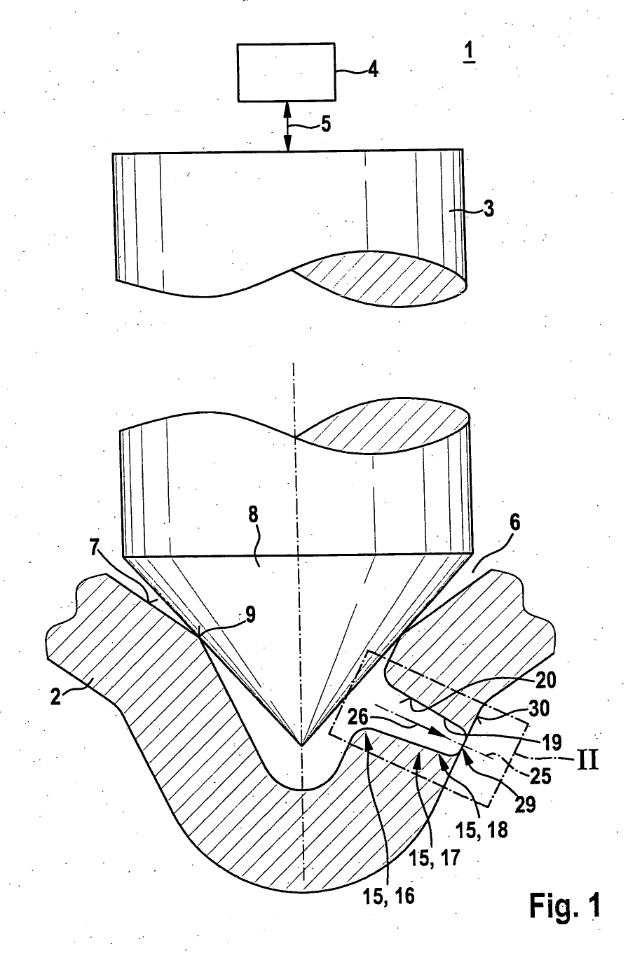

FIG. 1 shows a fuel injection valve in a schematic, fragmentary sectional view, in one exemplary embodiment of the invention. The fuel injection valve 1 can in particular serve as an injector for fuel injection systems of air-compressing, self-igniting internal combustion engines. A preferred use of the fuel injection valve 1 is for a fuel injection system with a common rail, which supplies diesel fuel at high pressure to a plurality of fuel injection valves 1. However, the fuel injection valve 1 of the invention is suitable for other applications as well.

The fuel injection valve 1 shown in fragmentary form in FIG. 1 has a nozzle body 2, in which a nozzle needle 3 is supported axially displaceably. The nozzle needle 3 is actuatable by means of an actuation device 4. The actuation device 4 may for instance have mechanical and hydraulic components, and the triggering can be effected by means of a piezoelectric actuator or a solenoid. The action of the actuation device 4 on the nozzle needle 3 is illustrated by the double arrow 5.

The fuel injection valve 1 communicates in a suitable way with a fuel pump, for instance via a common rail. In operation of the fuel injection valve 1, there is accordingly fuel at high pressure in a combustion chamber 6 provided inside the nozzle body 2.

The nozzle body 2 has a valve seat face 7, which cooperates with a valve closing body 8 of the nozzle needle 3 to form a sealing seat. In this exemplary embodiment, the sealing seat is formed at a sealing edge 9 of the valve seat face 7. Downstream of the sealing edge 9, the nozzle body 2 has at least one injection port 15. In this exemplary embodiment, the injection port 15 is embodied as a blind bore nozzle injection port 15. In a correspondingly embodied fuel injection valve 1, the injection port 15 can also be embodied as a seat port nozzle injection port.

The injection port 15 has an inflow region 16, a middle region 17, and an outer port region 18. The middle region 17 is located between the inflow region 16 and the outer port region 18 of the injection port 15. In the inflow region 16, the injection port 15 is embodied in rounded fashion. Furthermore, the injection port 15 has a taper in the outer port region 18.

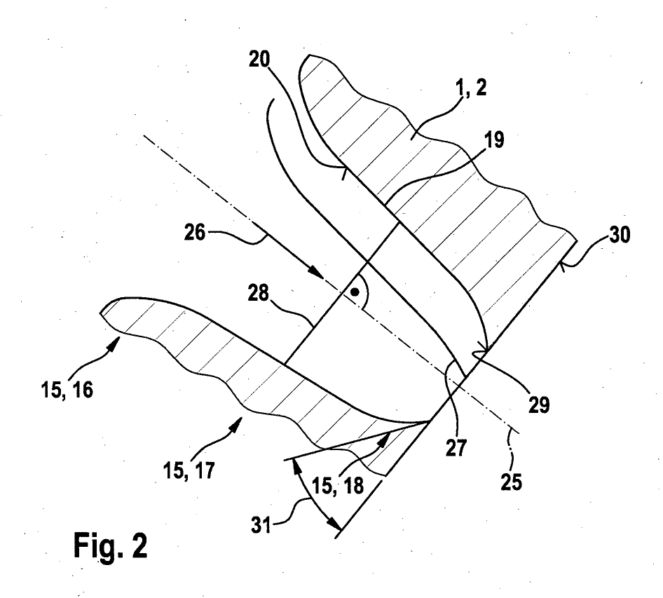

The injection port 15 is also embodied in rounded fashion in the outer port region 18. Overall, a wall 19 of the injection port 15 is embodied such that no steps, corners, kinks, or the like are embodied in a surface 20 of the wall 19. The surface 20 of the wall 19 is thus embodied as at least essentially smooth and uniform. The embodiment of the injection port 15 is described in further detail hereinafter as well, in conjunction with FIG. 2.

FIG. 2 shows the fragment marked II in FIG. 1 of the nozzle body 2 of the fuel injection valve 1 in a schematic sectional view.

The injection port 15 has an axis 25, and the axis 25 is oriented at least approximately in a flow direction 26. The injection port 15 is embodied as at least approximately symmetrical relative to the axis 25.

In FIG. 2, by way of example a flow line 27 is shown, which extends along the surface 20 of the wall 19 of the injection port 15. It should be noted that the flow line 27, since it is located in the surface 20 of the wall 19, does not extend within the sectional plane shown in FIG. 2.

The flow line 27 is embodied as kink-free. As a result, the flow line 27 extends both steadily, that is, without steps, as well as uniformly, that is, without abrupt changes of direction along its path, along the surface 20 of the wall 19. As a result, eddies in particular are reduced or even prevented. As a result, high efficiency as fuel flows through the injection port 15 can be attained.

In FIG. 2, as an example, a cross-sectional area 28 is shown which is oriented perpendicular to the axis 25 of the injection port 15. The cross-sectional area 28 of the injection port 15 may for instance be embodied as at least approximately circular or elliptical. The injection port 15 is embodied such that the cross-sectional area 28 decreases along the axis 25 in the flow direction 26. This decrease takes place continuously; for example, a diameter of the cross-sectional area 28 decreases continuously, or at least one of the two primary axes of an elliptical cross-sectional area 28 is reduced steadily.

In the inflow region 16, the cross-sectional area 28 decreases initially relatively sharply. Moreover, in a middle region 17 of the injection port 15, the decrease of the cross-sectional area 28 is relatively slightly pronounced. In the outer port region 18, the decrease in the cross-sectional area 28 in the flow direction 26 along the axis 25 is again relatively sharply pronounced. The result is accordingly an S-shaped embodiment of the flow lines of the injection port 15, in particular of the flow line 27. This makes an advantageous flow through the injection port 15 possible, and as a result of the embodiment of the outer port region 18, a deflection is attained which leads to atomization, close to the nozzle, of the ejected fuel.

In the outer port region 18, the injection port 15 has an encompassing detachment edge 29, which is embodied for instance in circular or elliptical form. The detachment edge 29 is oriented toward at the axis 25 of the injection port 15. The detachment edge 29 reinforces the atomization of the ejected fuel. As a result, atomization of the fuel close to the nozzle is possible with high efficiency. The detachment edge 29 is embodied as sharp-edged a and burr-free.

In the sectional view, an acute angle 31 is embodied between an outer face 30 of the nozzle body 2 and the wall 19 in the outer port region 18.

The invention is not limited to the exemplary embodiments described.

1-11. (canceled)

12. A fuel injection valve, in particular an injector for fuel injection systems of air-compressing, self-igniting internal combustion engines, comprising:
a nozzle body, which has a valve seat face; and
a nozzle needle, which cooperates with the valve seat face to form a sealing seat in order to control a fuel flow to at least one injection port of the nozzle body, the injection port being provided downstream of the sealing seat and being embodied in rounded form in an inflow region of the injection port and having a taper, at least in an outer port region of the injection port.

13. The fuel injection valve as defined by claim 12, wherein the injection port is embodied as sharp-edged and burr-free in the outer port region.

14. The fuel injection valve as defined by claim 12, wherein a wall of the injection port is embodied such that a flow line, extending in a flow direction along a surface of the wall, is embodied as kink-free.

15. The fuel injection valve as defined by claim 13, wherein a wall of the injection port is embodied such that a flow line, extending in a flow direction along a surface of the wall, is embodied as kink-free.

16. The fuel injection valve as defined by claim 14, wherein the flow line extending along the surface of the wall is embodied as at least approximately S-shaped.

17. The fuel injection valve as defined by claim 15, wherein the flow line extending along the surface of the wall is embodied as at least approximately S-shaped.

18. The fuel injection valve as defined by claim 12, wherein a cross-sectional area of the injection port, located perpendicular to an axis of the injection port oriented at least essentially in a flow direction, decreases continuously along the axis in the flow direction.

19. The fuel injection valve as defined by claim 13, wherein a cross-sectional area of the injection port, located perpendicular to an axis of the injection port oriented at least essentially in a flow direction, decreases continuously along the axis in the flow direction.

20. The fuel injection valve as defined by claim 14, wherein a cross-sectional area of the injection port, located perpendicular to an axis of the injection port oriented at least essentially in a flow direction, decreases continuously along the axis in the flow direction.

21. The fuel injection valve as defined by claim 15, wherein a cross-sectional area of the injection port, located perpendicular to an axis of the injection port oriented at least essentially in a flow direction, decreases continuously along the axis in the flow direction.

22. The fuel injection valve as defined by claim 16, wherein a cross-sectional area of the injection port, located perpendicular to an axis of the injection port oriented at least essentially in a flow direction, decreases continuously along the axis in the flow direction.

23. The fuel injection valve as defined by claim 17, wherein a cross-sectional area of the injection port, located perpendicular to an axis of the injection port oriented at least essentially in a flow direction, decreases continuously along the axis in the flow direction.

24. The fuel injection valve as defined by claim 18, wherein the cross-sectional area, in the outer port region along the axis in the flow direction, decreases to a relatively sharply pronounced extent

25. The fuel injection valve as defined by claim 24, wherein the injection port, in the outer port region, has a detachment edge, which is oriented toward the axis of the injection port.

26. The fuel injection valve as defined by claim 12, wherein a cross-sectional area of the injection port, located perpendicular to an axis of the injection port oriented at least essentially in a flow direction, decreases uniformly in the flow direction in a middle region between the inflow region and the outer port region.

27. The fuel injection valve as defined by claim 26, wherein the decrease in the cross-sectional area in the flow direction in the middle region is relatively slightly pronounced.

28. The fuel injection valve as defined by claim 12, wherein the injection port is embodied as a blind bore nozzle injection port.

29. The fuel injection valve as defined by claim 23, wherein the injection port is embodied as a blind bore nozzle injection port.

30. The fuel injection valve as defined by claim 12, wherein the injection port is embodied as a seat port nozzle injection port.

31. The fuel injection valve as defined by claim 23, wherein the injection port is embodied as a seat port nozzle injection port.
